(19) United States
(12) Patent Application Publication
(10) Pub. No.: US 2014/0338360 A1
(43) Pub. Date: Nov. 20, 2014

(54) BLEED PORT RIBS FOR TURBOMACHINE CASE

(71) Applicant: United Technologies Corporation, (US)

(72) Inventors: Michael Ronan, East Hartford, CT (US); Daniel Carminati, Berlin, CT (US); Cheng-Zhang Wang, Glastonbury, CT (US)

(73) Assignee: United Technologies Corporation, Hartford, CT (US)

(21) Appl. No.: 13/712,113

(22) Filed: Dec. 12, 2012

Related U.S. Application Data
(60) Provisional application No. 61/703,973, filed on Sep. 21, 2012.

(51) Int. Cl. F02C 6/08

(52) U.S. Cl. CPC F02C 6/08
USPC 60/782; 60/785

(57) ABSTRACT

An example turbomachine structure includes a case having a radially extending port, and at least one rib configured to direct flow through and past the port.

### CROSS-REFERENCE TO RELATED APPLICATIONS

This application claims priority to U.S. Provisional Application No. 61/703,973, which was filed on 21 Sep. 2012 and is incorporated herein by reference.

### BACKGROUND

Turbomachines, such as gas turbine engines, typically include a fan section, a compression section, a combustion section, and a turbine section. Turbomachines may employ a geared architecture connecting portions of the compression section to the fan section.

Referring to FIGS. 1-3, a prior art compressor case 200 includes a bleed port 204 that communicates bleed air to an environmental control system of a turbomachine. The bleed port 204 includes structural ribs 206 strengthening the compressor case 200 in the area of the bleed port 204. The structural ribs 206 disrupt flow, of bleed air which can lead to undesirable pressure losses.

### SUMMARY

A turbomachine structure according to an exemplary aspect of the present disclosure includes, among other things, a case having a radially extending port, and at least one rib configured to direct flow through and past the port.

In a non-limiting embodiment of the foregoing turbomachine structure, the at least one rib is angled relative to a radial direction.

In a further non-limiting embodiment of either of the foregoing turbomachine structures, the at least one rib may comprise a rib that is angled relative to a radial direction and a rib that is aligned with the radial direction.

In a further non-limiting embodiment of any of the foregoing turbomachine structures, the at least one rib may extend radially past a perimeter of the port.

In a further non-limiting embodiment of any of the foregoing turbomachine structures, the at least one rib may comprise a rounded trailing end.

In a further non-limiting embodiment of any of the foregoing turbomachine structures, the port may be configured to communicate bleed air from a compressor section of a turbomachine.

In a further non-limiting embodiment of any of the foregoing turbomachine structures, the port may be configured to communicate bleed air to an environmental control system of an aircraft.

In a further non-limiting embodiment of any of the foregoing turbomachine structures, the at least one rib may comprise a middle rib extending in a radial direction, the middle rib positioned between outer ribs extending in a radial direction, the outer ribs angled toward the inner rib.

A turbomachine according to an exemplary aspect of the present disclosure includes, among other things, a compressor section having an annular case, a duct connected to a port within the case and configured to receive a flow of bleed air from the port, and at least one rib having a portion extending from the annular case into an interior of the duct.

In a non-limiting embodiment of the foregoing turbomachine, the structural ribs extend radially into the duct.

In a further non-limiting embodiment of either of the foregoing turbomachines, the port is positioned immediately aft a fourth stage of the compressor section.

In a further non-limiting embodiment of any of the foregoing turbomachines, the duct delivers the bleed air to an aircraft.

In a further non-limiting embodiment of any of the foregoing turbomachines, the at least one rib comprises a first rib that is angled relative to both a second rib and a radial axis.

A method of communicating bleed flow according to another exemplary aspect of the present disclosure includes, among other things, directing bleed flow through a port in a case into a duct utilizing ribs extending across the port and into the duct.

In a further non-limiting embodiment of the foregoing method of communicating bleed flow, at least some of the ribs are angled relative to a radial axis.

In a further non-limiting embodiment of the foregoing method of communicating bleed flow, the method includes directing flow that is radially beyond the port utilizing the ribs.

### DESCRIPTION OF THE FIGURES

The various features and advantages of the disclosed examples will become apparent to those skilled in the art from the detailed description. The figures that accompany the detailed description can be briefly described as follows:

FIG. 1 shows a perspective view of a prior art compressor case.

FIG. 2 shows an axial view of a portion the prior art compressor case of FIG. 1.

FIG. 3 shows flow through a port of the prior art compressor case of FIG. 1.

FIG. 4 shows a cross-section view of an example turbomachine

FIG. 5 shows a perspective view of a high-pressure compressor case of the turbomachine of FIG. 4.

FIG. 6 shows an axial view of a portion the high-pressure compressor case of FIG. 5.

FIG. 7 shows flow through a port of the high-pressure compressor case of FIG. 5.

### DETAILED DESCRIPTION

FIG. 4 schematically illustrates an example turbomachine, which is a gas turbine engine 20 in this example. The gas turbine engine 20 is a two-spool turbofan gas turbine engine that generally includes a fan section 22, a compression section 24, a combustion section 26, and a turbine section 28.

Although depicted as a two-spool turbofan gas turbine engine in the disclosed non-limiting embodiment, it should be understood that the concepts described herein are not limited to use with turbofans. That is, the teachings may be applied to other types of turbomachines and turbine engines including three-spool architectures. Further, the concepts described herein could be used in environments other than a turbomachine environment and in applications other than aerospace applications. One exemplary non-aerospace application is industrial gas turbine (IGT) engines.

In the example engine 20, flow moves from the fan section 22 to a bypass flowpath. Flow from the bypass flowpath generates forward thrust. The compression section 24 drives air along a core flowpath. Compressed air from the compression section 24 communicates through the combustion section 26. The products of combustion expand through the turbine section 28.

The example engine 20 generally includes a low-speed spool 30 and a high-speed spool 32 mounted for rotation about an engine central axis A. The low-speed spool 30 and the high-speed spool 32 are rotatably supported by several bearing systems 38. It should be understood that various bearing systems 38 at various locations may alternatively, or additionally, be provided.

The low-speed spool 30 generally includes a shaft 40 that interconnects a fan 42, a low-pressure compressor 44, and a low-pressure turbine 46. The shaft 40 is connected to the fan 42 through a geared architecture 48 to drive the fan 42 at a lower speed than the low-speed spool 30.

The high-speed spool 32 includes a shaft 50 that interconnects a high-pressure compressor 52 and high-pressure turbine 54.

The shaft 40 and the shaft 50 are concentric and rotate via bearing systems 38 about the engine central longitudinal axis A, which is collinear with the longitudinal axes of the shaft 40 and the shaft 50.

The combustion section 26 includes a circumferentially distributed array of combustors 56 generally arranged axially between the high-pressure compressor 52 and the high-pressure turbine 54.

In some non-limiting examples, the engine 20 is a high-bypass geared aircraft engine. In a further example, the engine 20 bypass ratio is greater than about six (6 to 1).

The geared architecture 48 of the example engine 20 includes an epicyclic gear train, such as a planetary gear system or other gear system. The example epicyclic gear train has a gear reduction ratio of greater than about 2.3 (2.3 to 1).

The low-pressure turbine 46 pressure ratio is pressure measured prior to inlet of low-pressure turbine 46 as related to the pressure at the outlet of the low-pressure turbine 46 prior to an exhaust nozzle of the engine 20. In one non-limiting embodiment, the bypass ratio of the engine 20 is greater than about ten (10 to 1), the fan diameter is significantly larger than that of the low-pressure compressor 44, and the low-pressure turbine 46 has a pressure ratio that is greater than about five (5 to 1). The geared architecture 48 of this embodiment is an epicyclic gear train with a gear reduction ratio of greater than about 2.5 (2.5 to 1). It should be understood, however, that the above parameters are only exemplary of one embodiment of a geared architecture engine and that the present disclosure is applicable to other gas turbine engines including direct drive turbofans.

In this embodiment of the example engine 20, a significant amount of thrust is provided by the bypass flow B due to the high bypass ratio. The fan section 22 of the engine 20 is designed for a particular flight condition—typically cruise at about 0.8 Mach and about 35,000 feet. This flight condition, with the engine 20 at its best fuel consumption, is also known as “Bucket Cruise” Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example engine 20 is less than 1.45 (1.45 to 1).

“Low Corrected Fan Tip Speed” is the actual fan tip speed in ft/sec divided by an industry standard temperature correction of [(Tram ° R)/(518.7° R)]̂0.5. The Temperature represents the ambient temperature in degrees Rankine. The Low Corrected Fan Tip Speed according to one non-limiting embodiment of the example engine 20 is less than about 1150 fps (351 m/s).

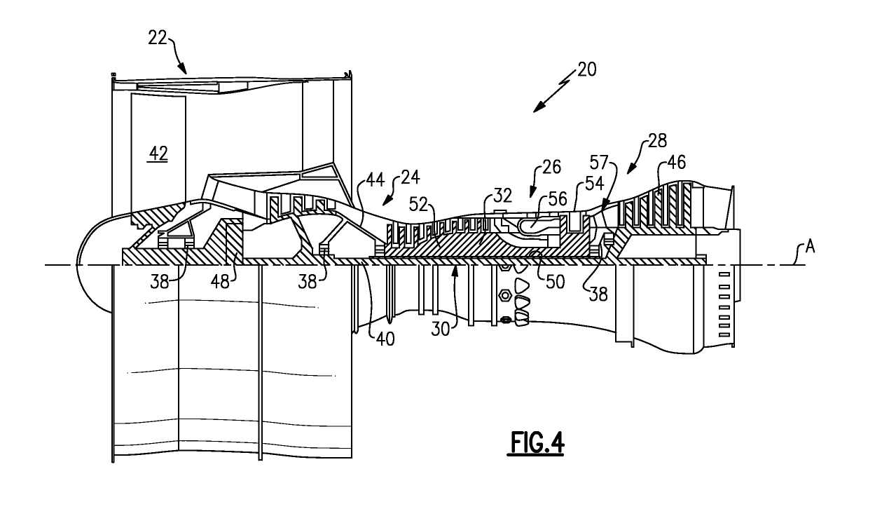

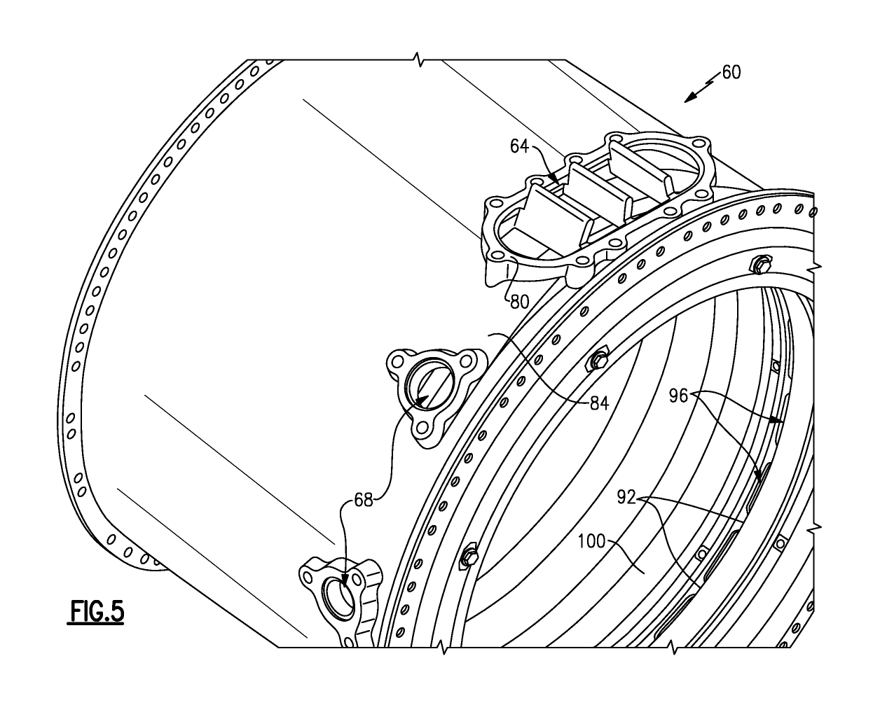

Referring now to FIGS. 5-7 with continuing reference to FIG. 4, a case 60 from the engine 20 includes bleed air ports 64 and 68. The case 60 is a turbomachine structure. The case 60 is case is a high-pressure case, but could be a case from another area in other examples. The case 60 is distributed annularly about the axis A.

In this example, the port 64 has a cross-sectional area that is larger than the ports 68. Also, the port 64 has an oval cross-section, and the ports 68 each have a circular cross-section.

The port 64 communicates bleed air radially from the high-pressure compressor 52 to a duct 72. The duct 72 communicates the bleed air to an aircraft propelled by the engine 20. The aircraft uses the bleed air communicated through the port 64 within the aircraft's environmental control system. The aircraft may utilize the bleed air for wing anti-icing, conditioning the cabin, pressurizing the cabin, etc. A lip 76 of the duct 72 attaches to an attachment flange 80 extending radially from a radially outer surface 84 of the case 60. The attachment flange 80 extends in a radial direction from an outer surface of the case 60. Radial is with reference to the axis A of the engine 20.

The ports 68 communicate bleed air to another duct (not shown) that then communicates the bleed air from the high-pressure compressor 52 to areas of the engine 20, such as bearing compartments and the turbine section 28.

The port 64 and the port 68 receive air from a manifold area 88, which is bounded radially by the case 60 and an inner case 92. Openings 96 within the inner case 92 permit flow of compressed air from the high-pressure compressor 52 into the manifold 88. The openings 96 are oval in this example.

The compressed air moves from the manifold 88 through the port 64 or 68. The compressed air may move circumferentially within the manifold 88 prior to exiting through the ports 64 and 68.

The example inner case 92, manifold 88, and ports 64 and 68, are positioned axially aft an outer air seal. Axially aft is relative to the direction of flow through the high-pressure compressor 52. The example outer air seal 100 is part of the fourth-stage of compression within the high-pressure compressor 52.

The port 64, due in part to its relatively large cross-sectional area, includes a plurality of ribs 108 extending across the port 64. The ribs 108 strengthen the case 60 in the area of the port 64. The ribs 108 are structural ribs.

The ribs 108 extend axially across the port 64 in this example. The ribs 108 may extend circumferentially in another example. The ribs 108 extend radially past the attachment flange 80 such that a portion of the ribs 108 extend radially past a perimeter of the opening and into the duct 72. The ribs 108 guide air through and past the port 64.

The example ribs 108 include a middle rib 108a and outer ribs 108b. The outer ribs 108b are angled relative to a radially extending axis. In this example, the outer ribs 108b are angled from between 30 to 35 degrees relative to a radially extending axis. The example outer ribs 108b are angled slightly toward the middle rib 108a. Angling the ribs 108b in this way helps guide circumferentially moving air from the manifold 88 into the duct 72.

The ribs 108 terminate at a rounded trailing end, which in this example has a diameter that is equal to the thickness of the ribs 108. The rounded trailing end reduces wakes associated with flow over the ribs 108. The rounded trailing end is trailing relative to the direction of flow through the port 64. The leading end of the ribs 108 are similarly rounded in some examples.

The ribs 108 are circumferentially aligned with structures in the inner case 92. That is a portion of the ribs 108 circumferentially overlaps structures in the inner case 92. Openings 96 in the inner case 92 are circumferentially aligned with the openings in the port 64.

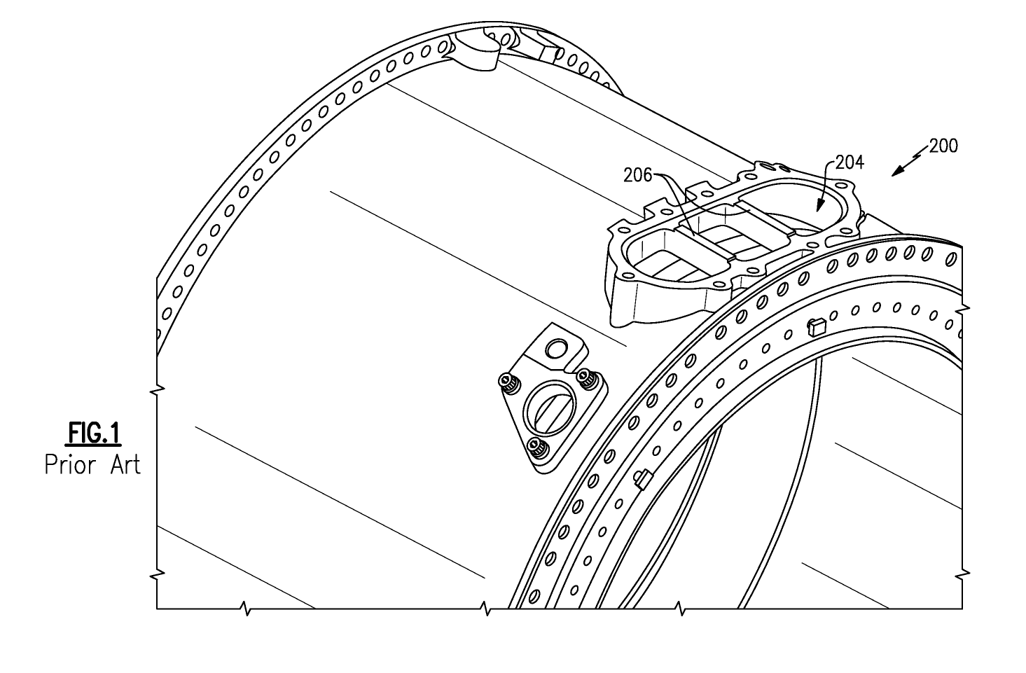

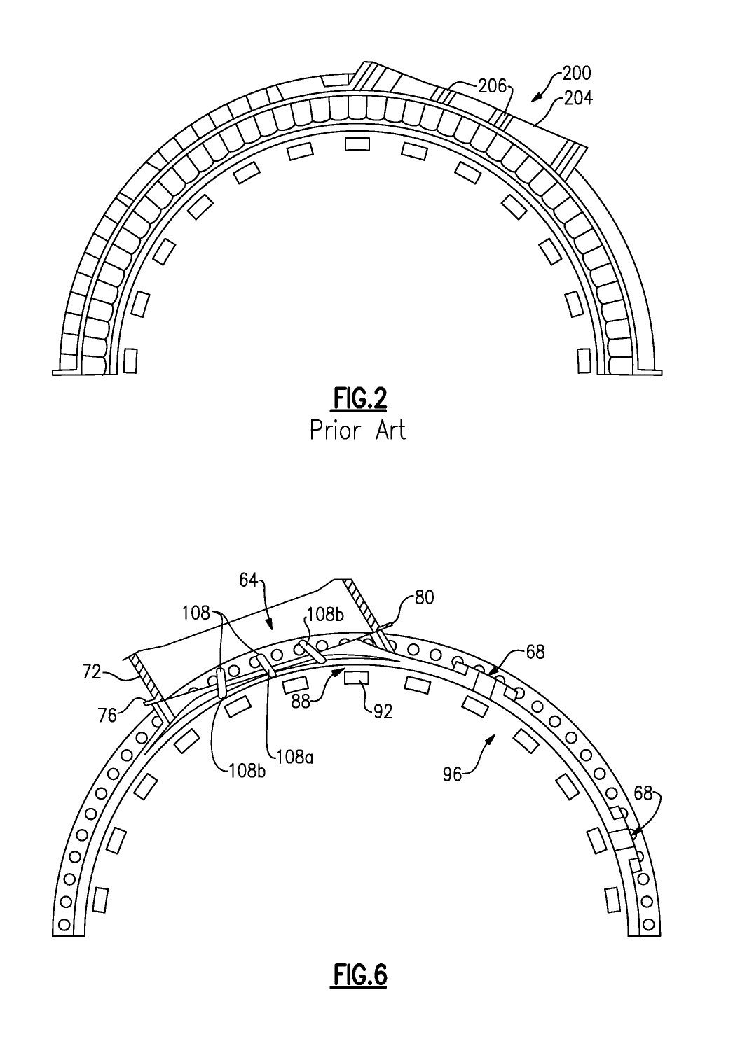

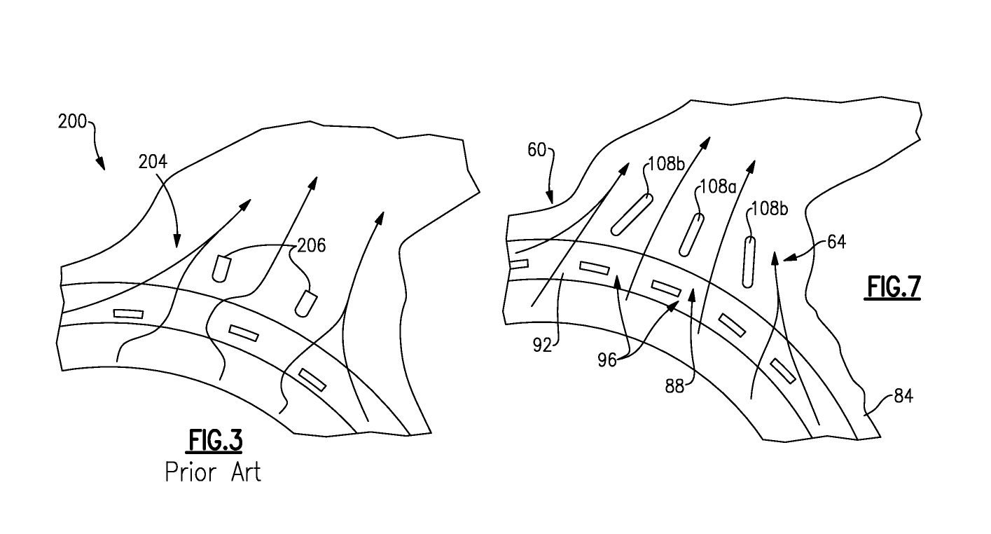

The ribs 108 facilitate lowering the pressure loss across the port 64 compared to the pressure loss across the prior art port 204 (FIG. 1). Flow through the port 64 is also more streamlined and less separated that the flow through the port 204 of the prior art.

The lower pressure losses associated with the optimized ribs 108 may allow for bleeds that switch between sources, such as a mid-compressor bleed into fuser bleed, to switch at lower power settings. Switching a lower power sources may reduce fuel consumption. Higher pressure resulting from this improvement may also allow other features in the system to create higher pressure drops than would otherwise be acceptable, resulting in further system-level optimization.

Features of the disclosed examples includes ribs that are placed and shaped to act as flow guides as well as structural members. The example ribs are extended radially in shape to reduce wakes, positioned to be in the wake of interruptions in the annular bleed from the engine core and other flow disruptions, and are aligned with the flow direction. The ribs of the disclosed examples also have substantially no increase in weight over the prior art design.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A turbomachine structure, comprising:
a case having a radially extending port; and
at least one rib configured to direct flow through and past the port.

2. The turbomachine structure of claim 1, wherein the at least one rib is angled relative to a radial direction.

3. The turbomachine structure of claim 1, wherein the at least one rib comprises a rib that is angled relative to a radial direction and a rib that is aligned with the radial direction.

4. The turbomachine structure of claim 1, wherein the at least one rib extends radially past a perimeter of the port.

5. The turbomachine structure of claim 1, wherein the at least one rib comprises a rounded trailing end.

6. The turbomachine structure of claim 1, wherein the port is configured to communicate bleed air from a compressor section of a turbomachine.

7. The turbomachine structure of claim 1, wherein the port is configured to communicate bleed air to an environmental control system of an aircraft.

8. The turbomachine structure of claim 1, wherein the at least one rib comprises a middle rib extending in a radial direction, the middle rib positioned between outer ribs extending in a radial direction, the outer ribs angled toward the inner rib.

9. A turbomachine comprising:
a compressor section having an annular case;
a duct connected to a port within the case and configured to receive a flow of bleed air from the port; and
at least one rib having a portion extending from the annular case into an interior of the duct.

10. The turbomachine of claim 9, wherein the structural ribs extend radially into the duct.

11. The turbomachine of claim 9, wherein the port is positioned immediately aft a fourth stage of the compressor section.

12. The turbomachine of claim 9, wherein the duct delivers the bleed air to an aircraft.

13. The turbomachine of claim 9, wherein the at least one rib comprises a first rib that is angled relative to both a second rib and a radial axis.

14. A method of communicating bleed flow comprising:
directing bleed flow through a port in a case into a duct utilizing ribs extending across the port and into the duct.

15. The method of claim 14, wherein at least some of the ribs are angled relative to a radial axis.

16. The method of claim 14, including directing flow that is radially beyond the port utilizing the ribs.
